(19) United States
(12) Patent Application Publication
(10) Pub. No.: US 2009/0108034 A1
(43) Pub. Date: Apr. 30, 2009

(54) Dispenser with a timed indicator

(76) Inventors: Christopher Michael Bechyne, Menasha, WI (US); Stephen Robert Kehn, Appleton, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/980,145

(22) Filed: Oct. 30, 2007

(51) Int. Cl. B67D 5/08; G04B 47/00; B67D 1/07; B67D 5/06

(52) U.S. Cl. 222/638; 222/23; 222/192; 368/1; 368/10

(57) ABSTRACT

A dispenser includes a delivery mechanism adapted to deliver a substance from a container to a discharge opening in the delivery mechanism when activated by a user. The dispenser also includes a housing attached to the delivery mechanism. The housing includes an indicator that produces a signal visible to the user when the delivery mechanism is activated. The signal is not visible prior to activation of the delivery mechanism. The signal remains integral with the housing after activation of the delivery mechanism. The signal remains visible only for a predetermined amount of time after activation of the delivery mechanism.

### BACKGROUND OF THE INVENTION

The benefits of proper hand washing are well documented. This is particularly apt after using the restroom. However, despite the known benefits, not all people regularly and properly wash their hands. This is particularly true with children who may not appreciate the benefits of hand washing and may not be attended to at wash times. As such, children may not wash their hands at all and/or may not wash their hands for an adequate amount of time and/or may not wash with an adequate cleaner. Parental supervision and coaching can improve the hand washing habits of children, but parents or caregivers are not always able to be with the child in the bathroom.

Several products have been introduced to encourage people to wash their hands for a proper length of time. For example, some proposed products include pads that apply a mark to the hand when soap is dispensed. The recipient of the soap and the mark are instructed to wash their hands until the mark is removed. In another example, some proposed products include a soap dispenser base designed to hold a soap dispenser. When pressure is applied to the soap dispenser, a timing means and a signal means in the base are activated.

While these products may improve hand washing habits when used, they may also fail to interest children and therefore may not be used. Thus, there remains a need for a dispenser that attracts and holds the attention of children and encourages them to wash their hands for a predetermined amount of time to ensure proper hand washing hygiene.

### SUMMARY OF THE INVENTION

In response to the needs described above, in one aspect, the present invention provides a dispenser having a delivery mechanism adapted to deliver a substance from a container to a discharge opening in the delivery mechanism when activated by a user. The dispenser also includes a housing attached to the delivery mechanism. The housing includes an indicator that produces a signal visible to the user when the delivery mechanism is activated. The signal is not visible prior to activation of the delivery mechanism, the signal remains integral with the housing after activation, and the signal remains visible only for a predetermined amount of time after activation of the delivery mechanism.

In various embodiments, the housing may define an interior space and the dispenser may include a timer, a switch, and/or a power source located at least partially within the interior space. In some embodiments, the indicator, the timer, the switch, and/or the power source may be contained within a waterproof enclosure. In some embodiments, the waterproof enclosure may include a transparent polyethylene bag. In various embodiments, the indicator may be located within the interior space and the signal may be visible to the user through the housing.

In various embodiments, the housing may be made of polypropylene and may include a first area having a first thickness and a second area having a second thickness less than the first thickness. In these embodiments, the second area may be at least one cm² in area and the signal may be more visible through the second portion than through the first portion.

In some embodiments, the housing may be shaped like an animal head. In some embodiments, the housing may include a mouth and the housing may be oriented on the delivery mechanism such that the mouth is proximate the discharge opening.

In various embodiments, a portion of the housing may be positioned to at least partially deflect at least a portion of the substance as the substance is delivered from the discharge opening.

In another aspect, the present invention provides a dispenser that includes a mechanical, non-aerosol, pump having a pump head and a discharge opening, wherein the pump is adapted to deliver a dose of soap from a container to the discharge opening when the pump head is depressed. The dispenser also includes a housing attached to the pump head wherein the housing is shaped like an animal head having a mouth positioned proximate the discharge opening. The housing defines an interior space and includes a light emitting diode, a timer, a switch, and/or a battery located at least partially within the interior space. The housing is attached to the pump head such that pressing the housing towards the container activates the switch and depresses the pump head. Activating the switch activates the light emitting diode for a duration of time controlled by the timer. Depressing the pump head delivers a dose of soap from the discharge opening.

In various embodiments, the housing may further define an opening and the switch may be positioned in the opening such that depressing the housing presses the switch against the pump head.

In various embodiments, the light emitting diode may flash on and off during the duration of time. In various embodiments, the light emitting diode, the timer, the switch, and/or the battery may be enclosed within a transparent waterproof enclosure.

In various embodiments, a portion of the housing is positioned to at least partially deflect at least a portion of the soap as the soap is delivered from the discharge opening.

In some embodiments, the housing further includes a nose, a first area having a first thickness, and a second area having a second thickness less than the first thickness, wherein the second area is at least one cm² in area and is located proximate the nose.

In another aspect, the present invention provides a dispenser that includes a mechanical, non-aerosol, foam pump having a pump head and a discharge opening. The pump is adapted to deliver a dose of foam soap from a container through the discharge opening when the pump head is depressed. The dispenser also includes a housing attached to the pump head wherein the housing is shaped like an animal head and includes a nose and a mouth. The housing defines a first area having a first thickness and a second area having a second thickness less than the first thickness wherein the second area is at least one cm² in area and is located proximate the nose. The housing is positioned such that the mouth is proximate the discharge opening. The housing defines an interior space and includes a transparent waterproof enclosure disposed at least partially within the interior space. The transparent waterproof enclosure defines a waterproof interior space and includes a light emitting diode, a timer, a switch, and a battery disposed within the waterproof interior space. The housing further includes an opening wherein the switch is positioned relative to the opening such that depressing the housing presses the switch and at least a portion of the waterproof enclosure against the pump head and thereby depresses both the switch and the pump head. Depressing the switch activates the light emitting diode for a duration of time controlled by the timer. Depressing the pump head delivers a dose of soap from the discharge opening.

In various embodiments, the housing may be attached to the pump head by a snap attachment.

In various embodiments, the light emitting diode, switch, battery, and/or timer may be integrated with a printed circuit board.

In various embodiments, the light emitting diode may flash on and off during the duration of time.

In various embodiments, the light emitting diode may be positioned proximate the second area.

### BRIEF DESCRIPTION OF THE DRAWINGS

FIG. 1 representatively illustrates one embodiment of an exemplary dispenser of the present invention.

FIG. 2 representatively illustrates a portion of the dispenser of FIG. 1 with portions cut away to illustrate underlying features.

FIG. 3 representatively illustrates one embodiment of an exemplary waterproof enclosure of the present invention.

### DETAILED DESCRIPTION OF THE INVENTION

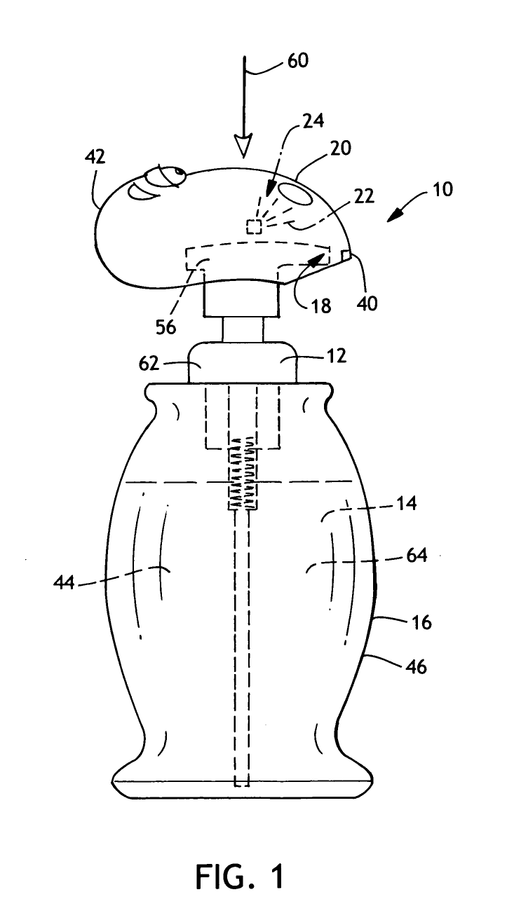

FIG. 1 representatively illustrates one embodiment of a dispenser 10 of the present invention. The dispenser 10 includes a delivery mechanism 12 and a housing 20. The delivery mechanism 12 is adapted to deliver a substance 14 from a container 16 to a discharge opening 18 in the delivery mechanism 12 when the delivery mechanism 12 is activated by a user. The housing 20 is attached to the delivery mechanism 12 and includes an indicator 22. The housing 20 is configured such that activation of the delivery mechanism 12 also activates the indicator 22 which produces a signal 24. In various embodiments, the indicator 22 may produce a signal 24 that is visible to the user when the indicator 22 is activated.

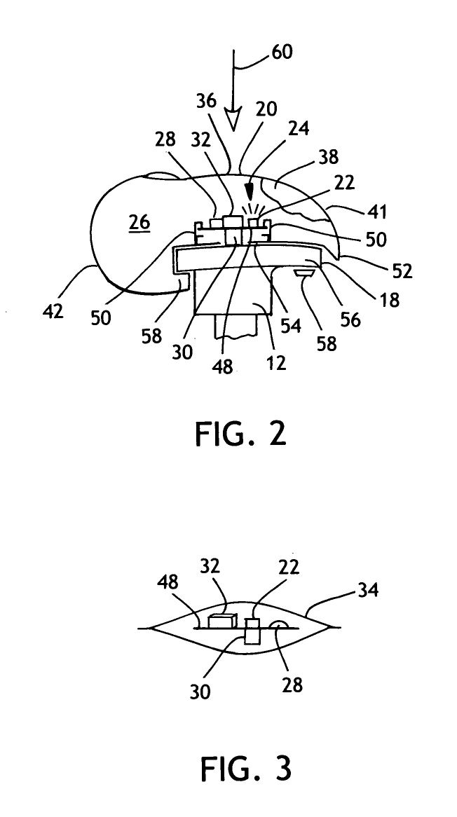

In some embodiments, the housing 20 may further define an interior space 26. For example, FIG. 2 representatively illustrates a portion of the dispenser 10 of FIG. 1 wherein the part of the housing 20 that is facing the viewer is cut away to illustrate the interior space 26. In various embodiments, and as illustrated in FIG. 2, the interior space 26 may include a timer 28, a switch 30, an indicator 22, or a power source 32, or combinations thereof, located at least partially within the interior space 26. However, in various embodiments, at least one of the timer 28, the switch 30, the indicator 22, and the power source 32 may be located partially or completely outside the interior space 26.

In various embodiments, the indicator 22 may be any suitable device for producing one or more signals 24. For example, at least one indicator 22 may be an audio device suitable for producing at least one auditory signal and/or at least one indicator 22 may be a device suitable for producing at least one visual signal. In preferred embodiments, at least one indicator 22 produces at least one visual signal 24 in the form of light. The light may be produced from any suitable source. For example, the visual signal 24 may result from a light emitting diode, incandescent bulb, fluorescent light, or the like, or combinations thereof.

In various embodiments, at least one indicator 22 may produce a visual signal and may be located, at least partially, on or near an outer surface 42 of the housing 20. In some embodiments, at least one indicator 22 may be located at least partially within the interior space 26 of the housing 20. In some embodiments, at least one indicator 22 may be located at least partially in an interior space 44 of the container 16. In some embodiments, at least one indicator 22 may be located at least partially on an outer surface 46 of the container 16. In some embodiments, at least one indicator 22 may be associated with an interior space and/or an exterior space defined by the delivery mechanism 12. In various embodiments, any combination of these various locations is contemplated.

The indicator 22 may be activated by a switch 30 and regulated by a timer 28. The switch 30 may be any device suitable for completing a circuit and/or opening a circuit that includes an indicator. For example, the switch 30 may be a toggle switch, a proximity switch, a mercury switch, a wafer switch, a DIP switch, a reed switch, an in-line switch, push-button switch, rocker switch, micro-switch, or the like, or combinations thereof. In the Figures, the switch 30 is illustrated as a push-button switch. In some embodiments, the switch 30 may be biased to return an actuator within the switch to a predetermined position.

The timer 28 may be any suitable device for regulating the duration of time the indicator 22 is active and thus producing a signal 24. In some embodiments, the timer 28 may be part of any suitable controller and will be referred to herein as a timer/controller 28. For example, the timer/controller 28 may be part of an application specific integrated circuit (ASIC). The timer/controller 28 may be adapted by known methods to activate and/or deactivate the indicator 22 in any desirable pattern and/or for any suitable duration of time. For example, the timer/controller 28 may cause the indicator 22 to produce a continuous signal 24 for a predetermined duration of time. In other examples, the timer/controller 28 may cause the indicator 22 to produce an intermittent signal 24 for a predetermined amount of time at a predetermined interval. In yet other examples, the timer/controller 28 may cause the indicator 22 to produce an intermittent signal 24 at varying intervals. For example, the timer/controller 28 may cause the indicator 22 to produce an intermittent signal 24 at a first interval for a first period of time and then cause the indicator 22 to produce an intermittent signal 24 at a second interval for a second period of time. The first interval and the second interval may be the same or may be different. The first period of time and the second period of time may be the same or may be different. In some embodiments, the timer/controller 28 may cause the indicator 22 to produce a signal 24 that communicates a message. For example, a flashing signal 24 may utilize Morse code to communicate a message. In other embodiments, a flashing signal 24 may have a decreasing interval of flashing as the predetermined time period expires.

Any suitable power source 32 may be utilized to activate the indicator 22. In preferred embodiments, the power source 32 is one or more batteries. In various embodiments, the power source 32, timer/controller 28, indicator 22, and/or switch 30 may be included as part of a circuit board 48. In some embodiments, the timer/controller 28, the power source 32, the indicator 22, and/or the switch 30 may be part of a printed circuit board fixed within the housing. As used herein, the term “fixed” refers to a circuit board that is physically attached within the housing 20 such that the printed circuit board 48 does not appreciably move relative to the housing 20. In various embodiments, the circuit board 48 may be fixed within the housing 20 by any suitable connection means. For example, the circuit board 48 may be held in place by clips, screws, adhesives, or other fasteners, and the like, and combinations thereof. For example, as illustrated in FIG. 2, the circuit board 48 is fixed within the housing 20 by clips 50.

In some embodiments, the indicator 22, the timer 28, the switch 30, and/or the power source 32 may be contained within a waterproof enclosure 34. For example, FIG. 3 representatively illustrates an indicator 22, a timer 28, a switch 30, and a power source 32 attached to a circuit board 48 all contained within a waterproof enclosure 34. In various embodiments, the waterproof enclosure 34 may be made in any suitable shape or size and may be made from any suitable material capable of protecting the contents from water or other damaging fluids. The waterproof enclosure 34 may be made from rigid materials or flexible materials. The waterproof enclosure 34 may be opaque or may have any suitable degree of transparency. For example, in some embodiments the waterproof enclosure 34 may be made from a polyethylene film that is virtually transparent, flexible, and in the form of a sealed bag. One advantage of a virtually transparent waterproof enclosure 34 is the ability of an indicator 22 located within the waterproof enclosure 34 to produce a visible signal 24 that can be seen through the waterproof enclosure 34. One advantage of a flexible waterproof enclosure 34 is the ability of a switch 30 to be located within the waterproof enclosure 34 and still be manipulated through the waterproof enclosure 34 without interference to the function of the switch 30.

In some embodiments, and as illustrated in FIGS. 1 and 2, the indicator 22 may be located within the interior space 26 of the housing 20 and may be visible to a user through the housing 26. The indicator 22 may be made visible through the housing 20 by any suitable means. In some embodiments, any or all of the housing may be at least partially transparent. In other embodiments, portions of the housing may be removed to make the indicator visible. In other embodiments, portions of the housing may be thinned to make the indicator more visible in the thinned portions.

Referring now to FIG. 2, in some embodiments, the housing 20 defines a first area 36 of at least five cm² and a second area 38 of at least one cm². The first area 36 has a first light transmittance and the second area 38 has a second light transmittance greater than the first light transmittance such that a visual signal 24 is more visible through the second area 38 than through the first area 36. In some embodiments, the first area 36 may have a first thickness and the second area 38 may have a second thickness less than the first thickness such that a visual signal 24 is more visible through the second area 38 than through the first area 36.

The housing 20 is representatively illustrated herein as having a hippopotamus-shaped head. However, it is contemplated that the housing 20 may be formed in any suitable shape or size. The housing 20 may be shaped like any portion of any animal, person, or object. In some embodiments, the housing 20 may be any suitable geometric or irregular shape. In some embodiments the housing 20 may be shaped like the head of a person or animal and may include a mouth 40. Also, in some embodiments, the housing 20 may be oriented on the delivery mechanism 12 such that the mouth 40 is located proximate the discharge opening 18. In these embodiments, the substance 14 delivered from the discharge opening 18 appears as if it is exiting the mouth 40 of the head-shaped housing 20. In some embodiments, the housing may be shaped like the head of a person or animal and may include a nose 41. In some embodiments, the nose 41 may include the second area 38 that permits greater light transmittance therethrough.

In some embodiments, the housing 20 may be positioned relative to the discharge opening 18 of the delivery mechanism 12 such that at least some of the substance 14 delivered from the discharge opening 18 is at least partially deflected by a portion of the housing 20. For example a deflector portion 52 of the housing 20 may extend at least partially in front of the discharge opening 18 such that when the substance 14 is delivered from the discharge opening 18 at least a portion of the substance 14 strikes the deflector portion 52 of the housing 20 and is redirected by the deflector portion 52. Use of a deflector portion 52 may be useful for promoting downward dispensing of soap into the hand of a user and may minimize “overshooting” the hand.

In some embodiments, the housing 20 may include the switch 30 located within the interior space 26 and a portion of the housing 20 may be configured to flex when pressed against the delivery mechanism 12. In these embodiments, the switch 30 may be positioned within the housing 20 proximate the portion of the housing 20 that flexes such that the flexing portion activates the switch 30 when flexed.

In some embodiments, the housing 20 may further define an opening 54. In some embodiments, the switch 30 may be positioned in the opening 54 such that the switch 30 may be accessed and activated more easily. For example, in some embodiments, the switch 30 may be located within the opening 54 such that depressing the housing 20 against the delivery mechanism 12 in the direction indicated by the arrow 60 also depresses the switch 30 against the delivery mechanism 12 thereby activating the switch 30 without necessarily flexing a portion of the housing 20.

In some embodiments, the housing 20 may be a one-piece plastic part with a living hinge that at least partially contains the indicator 22, the timer/controller 28, the switch 30, and/or the power source 32 in an interior space 26. The housing 20 may then be pivoted about the living hinge and closed using a mechanical locking system thereby deterring access to the interior space 26.

In various embodiments, the housing 20 may be attached to the delivery mechanism 12 by any suitable means. For example, the housing 20 may be attached to the delivery mechanism 12 with adhesives, thermal fusing, mechanical attachments, integral forming, and the like, and combinations thereof. In various embodiments, the housing 20 may be attached such that the housing 20 may be removed by a user without damaging the housing 20 or the delivery mechanism 12. In other embodiments, the housing 20 may be attached such that the housing 20 may not be easily removed by a user without damaging the housing 20 or the delivery mechanism 12. For purposes of illustration, the housing 20 of the present invention will be described and illustrated as being attached by clips 58 to a delivery mechanism 12 that includes a pump head 56. This is referred to herein as a “snap attachment.” A snap attachment is an integrated mechanical attachment but is distinguished from gluing, melting, fusing, or integral forming in that the housing remains a distinct and separate piece from the pump head. However, one skilled in the art will readily appreciate that the housing 20 may be attached to any other suitable portion(s) or component(s) of the delivery mechanism. In other embodiments, the substance 14 may pass directly through the housing 20, thereby essentially using the housing 20 as the pump head 56. In these embodiments, the housing 20 may be attached to any other suitable portion of the delivery mechanism 12.

In various embodiments, the delivery mechanism 12 may be any suitable device capable of delivering a substance 14 located within the container 16 to the discharge opening 18 when the delivery mechanism 12 is activated. Activation of the delivery mechanism 12 may be by any suitable means. In some embodiments, the delivery mechanism 12 may include a pressurized system and a valve wherein activation includes opening the valve and allowing a pressurized substance located within the container to move through the valve and through the discharge opening. Aerosol deodorant sprays and continuous spray sunscreens are examples of this type of delivery mechanism.

In some embodiments, the delivery mechanism 12 may include any suitable mechanical, non-aerosol, pump dispenser. One suitable delivery mechanism 12 is the WATERGUARD WRD4 mechanical, non-aerosol, foam dispenser available from Rexam Airspray having offices in Pompano Beach, Fla., U.S.A. The mechanical, non-aerosol, foam dispensers create foam without the use of gas propellants. The liquids and air are mixed with a stroke of the pump head to deliver a dose of foam. In other words, in these embodiments, the delivery mechanism 12 is activated by depressing the pump head 56 in the direction indicated by arrow 60.

The dispensers 10 of the present invention may be adapted to deliver any suitable substance 14 from the container 16 to the discharge opening 18. Suitable substances 14 include, for example, hand soap, shampoo, body wash, baby wash, hair conditioner, detangler, lotion, toothpaste, hand sanitizer, and the like.

In various embodiments, the container 16 may be made of any suitable material. For example, the container 16 may be made from plastic, metal, glass, and the like, and combinations thereof. Suitable plastics include, for example, polypropylene. Suitable metals include, for example, steel and aluminum.

In various embodiments, the container may be made in any suitable shape and/or size. For example, the containers may have surfaces that are smooth, textured, embossed, irregular, and combinations thereof. The containers may include portions that are straight, curved, sloped, irregular, angular, and the like, and combinations thereof. The containers may have concave curves, convex curves, or combinations thereof. The containers may be made by any suitable process. For example, the containers may be made by blow molding, extruding, casting, spinning, stamping, and the like, and combinations thereof.

In various embodiments the containers may include part of a coupling system wherein the coupling system is adapted to connect the delivery mechanism 12 to the container 16 and bring the delivery mechanism 12 into fluid communication with a substance 14 within the container 16. In some embodiments, the coupling system may include a coupler associated with the container 16. For example, a suitable coupler may include a threaded neck associated with the container 16 adapted to connect with a threaded delivery mechanism 12 to create a threaded fitting. Other suitable coupling systems may include pressure fittings, snap fittings, suction fittings, bayonet fittings, thermal fittings, adhesive fittings, and the like, and combinations thereof.

While the invention has been described in detail with respect to specific embodiments thereof, it will be appreciated that those skilled in the art, upon attaining understanding of the foregoing will readily appreciate alterations to, variations of, and equivalents to these embodiments. Accordingly, the scope of the present invention should be assessed as that of the appended claims and any equivalents thereto. Additionally, all combinations and/or sub-combinations of the disclosed embodiments, ranges, examples, and alternatives are also contemplated.

1. A dispenser comprising,
a delivery mechanism adapted to deliver a substance from a container to a discharge opening in the delivery mechanism when activated by a user,
a housing attached to the delivery mechanism, the housing comprising an indicator that produces a signal visible to the user when the delivery mechanism is activated; wherein the signal is not visible prior to activation of the delivery mechanism, the signal remains integral with the housing after activation, and the signal remains visible only for a predetermined amount of time after activation of the delivery mechanism.

2. The dispenser of claim 1 wherein the housing further defines an interior space and wherein the dispenser comprises a timer, a switch, and a power source and the timer, the switch, and the power source are located at least partially within the interior space.

3. The dispenser of claim 2 wherein the indicator, the timer, the switch, and the power source are contained within a waterproof enclosure.

4. The dispenser of claim 3 wherein the waterproof enclosure comprises a transparent polyethylene bag.

5. The dispenser of claim 2 wherein the indicator is located within the interior space and the signal is visible to the user through the housing.

6. The dispenser of claim 5 wherein the housing is made of polypropylene and comprises a first area having a first thickness and a second area having a second thickness less than the first thickness wherein the second area is at least one cm² and wherein the signal is more visible through the second portion than through the first portion.

7. The dispenser of claim 1 wherein the housing is shaped like an animal head.

8. The dispenser of claim 7 wherein the housing includes a mouth and the housing is oriented on the delivery mechanism such that the mouth is proximate the discharge opening.

9. The dispenser of claim 1 wherein a portion of the housing is positioned to at least partially deflect at least a portion of the substance as the substance is delivered from the discharge opening.

10. A dispenser comprising,
a mechanical, non-aerosol, pump having a pump head and a discharge opening, wherein the pump is adapted to deliver a dose of soap from a container to the discharge opening when the pump head is depressed;
a housing attached to the pump head, the housing being shaped like an animal head having a mouth positioned proximate the discharge opening, the housing defining an interior space comprising a light emitting diode, a timer, a switch, and a battery, wherein the light emitting diode, the timer, the switch, and the battery are located at least partially within the interior space;
the housing being attached to the pump head such that pressing the housing activates the switch and depresses the pump head, wherein activating the switch activates the light emitting diode for a duration of time controlled by the timer and depressing the pump head delivers a dose of soap from the discharge opening.

11. The dispenser of claim 10 wherein the housing further defines an opening and the switch is positioned in the opening such that depressing the housing depresses the switch against the pump head.

12. The dispenser of claim 10 wherein the light emitting diode flashes on and off during the duration of time.

13. The dispenser of claim 10 wherein the light emitting diode, the timer, the switch, and the battery are enclosed within a transparent waterproof enclosure.

14. The dispenser of claim 10 wherein a portion of the housing is positioned to at least partially deflect at least a portion of the soap as the soap is delivered from the discharge opening.

15. The dispenser of claim 10 wherein the housing further comprises a nose, a first area having a first thickness, and a second area having a second thickness less than the first thickness, wherein the second area is at least one cm² and is located proximate the nose.

16. A dispenser comprising,
a mechanical, non-aerosol, foam pump having a pump head and a discharge opening, wherein the pump is adapted to deliver a dose of foam soap from a container through the discharge opening when the pump head is depressed,
a housing attached to the pump head,
the housing being shaped like an animal head comprising a nose and a mouth,
the housing defining a first area having a first thickness and a second area having a second thickness less than the first thickness wherein the second area is at least one cm² and is located proximate the nose;
the housing being positioned such that the mouth is proximate the discharge opening;
the housing defining an interior space and comprising a transparent waterproof enclosure disposed at least partially within the interior space, the transparent waterproof enclosure defining a waterproof interior space comprising a light emitting diode, a timer, a switch, and a battery disposed within the waterproof interior space;
the housing further comprising an opening wherein the switch is positioned relative to the opening such that depressing the housing depresses the switch and at least a portion of the waterproof enclosure against the pump head and depresses both the switch and the pump head to activate the light emitting diode for a duration of time controlled by the timer and to deliver a dose of soap from the discharge opening.

17. The dispenser of claim 16 wherein the housing is attached to the pump head by a snap attachment.

18. The dispenser of claim 17 wherein the light emitting diode, switch, battery, and timer are integrated with a printed circuit board.

19. The dispenser of claim 16 wherein the light emitting diode flashes on and off during the duration of time.

20. The dispenser of claim 16 wherein the light emitting diode is positioned proximate the second area.
